(19) United States
(12) Patent Application Publication
(10) Pub. No.: US 2005/0082711 A1
(43) Pub. Date: Apr. 21, 2005

(54) Method of manufacturing a composite product, and composite product

(76) Inventors: Markku Vilkki, Lahti (FI); Kari Kirjavainen, Tampere (FI)

Correspondence Address: YOUNG & THOMPSON, 745 SOUTH 23RD STREET, 2ND FLOOR, ARLINGTON, VA, 22202, US

(21) Appl. No.: 10/684,498

(22) Filed: Oct. 15, 2003

(51) Int. Cl. B29C 47/00

(52) U.S. Cl. 264/122; 264/211.21

(57) ABSTRACT

Natural fiber material and binding agent is fed to a materials treating apparatus, and a composite product is formed of these with the apparatus. Also material reacting with water is fed to the apparatus. The natural fiber material is fed in such a form that its moisture percentage is more than 1%, whereby the material reacting with water reacts with the water present in and/or released from the natural fiber material. Thus, the composite product comprises natural fiber material, binding agent and material having reacted with the water in the natural fiber material.

### BACKGROUND OF THE INVENTION

The invention relates to a method of manufacturing a composite product.

Further, the invention relates to a composite product.

In the manufacture of polyethylene products, in for example extrusion, injection molding, mold casting and other techniques, cross-linking is used to improve properties of the final product. In order to achieve cross-linking, for instance silane-grafted polyethylene sorts are used together with a separate catalyst to be dosed to the process. It is possible to achieve cross-linking also by absorbing or dosing peroxide into polyethylene. Also other methods can be used for cross-linking, such as using a hydrochloric acid solution or beta radiation. What is essential in connection with cross-linking with regard to the production process is that the desired chemical reaction, i.e. polyethylene cross-linking, must not start during the melting processing of plastic or the form-molding process of the product in the materials treating apparatus but only outside the apparatus after the final product has first been brought to the desired form by a tool.

In the manufacture of natural fiber—plastic composite products, the bond between the fiber and the plastic can be improved by using different chemical auxiliary agents, such as maleated polypropylenes or polyethylenes, as well as aminosilane compounds. Thus, the reaction is intended to take place in connection with processing at the melt stage in the materials treating apparatus. The object of use of chemical auxiliary agents is to function as a coupling agent between the fiber and the plastic matrix, but the intention is typically not to affect specifically the rheological or other corresponding processing properties of the basic plastic.

Typically, when processing natural fiber, such as wood, into plastics to function as composite material, the water/moisture released from the fiber is a great problem which causes different processing problems and detrimental effects on the properties of the final product. Thus, the wood is typically carefully dried in such a way that the residue moisture content is below 1% at the stage where the fiber is fed to the materials treating apparatus. There have been attempts to solve the moisture problem also by developing extrusion apparatus and their combination processes in which the moisture released is removed from the process. However, the existing apparatus have multiple stages, or several separate apparatus are used in series or in parallel. Thus, the investment costs of the apparatus are high and still, they do not allow utilization of moist wood, such as sawdust or by-products of mechanical wood-processing industry, for example, without predrying.

### BRIEF DESCRIPTION OF THE INVENTION

An object of this invention is to provide a new kind of method for manufacturing a composite product, and a composite product.

The method according to the invention is characterized by comprising providing one or more materials treating apparatus; feeding natural fiber material, binding agent and material reacting with water to the materials treating apparatus, whereby the natural fiber material is fed so moist that its moisture percentage is more than 1%, whereby said material reacting with water reacts with the water present in said natural fiber material and/or released from it; and forming a composite product with the materials treating apparatus.

Further, the composite product according to the invention is characterized in that it comprises natural fiber material, binding agent and material having reacted with the water in the natural fiber material.

An essential idea of the invention is that natural fiber material and binding agent are fed to the materials treating apparatus, and a composite product is formed of these with the apparatus. Further, material reacting with water is fed to the apparatus. Further, the natural fiber material is fed in such a form that its moisture content is more than 1%, whereby the material reacting with water reacts with the water present in the natural fiber material and/or released from it.

An advantage of the invention is that natural fiber material needs not be dried substantially dry. In addition, the reaction of the material reacting with water can at least be started in the materials treating apparatus, whereby products with extremely good properties can be formed.

In connection with this description, the reaction of material and water also means that the material is dissolved in water.

### BRIEF DESCRIPTION OF THE FIGURES

The invention is explained in more detail in the attached drawings, in which

FIG. 1 shows schematically a side view and cross-section of a materials treating apparatus

FIG. 2 shows schematically an arrangement in connection with the materials treating apparatus according to FIG. 1 and

FIG. 3 shows schematically a top view of a second materials treating apparatus.

### DETAILED DESCRIPTION OF THE INVENTION

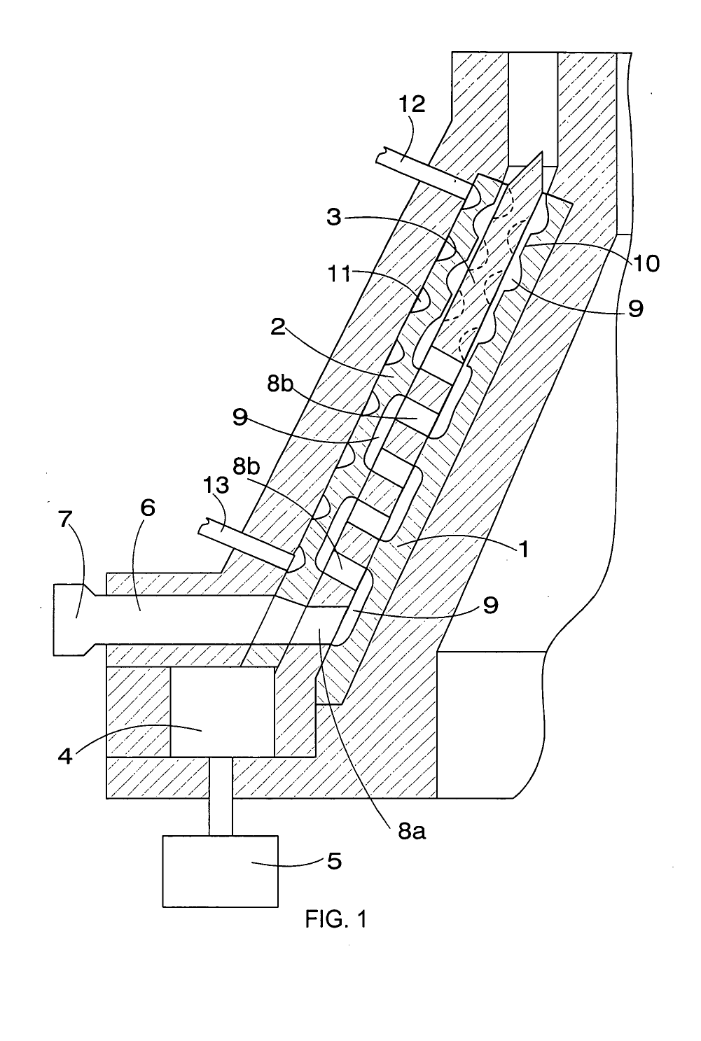

FIG. 1 shows one materials treating apparatus by means of which the method according to the invention can be preferably implemented. The type of this materials treating apparatus is a conical extruder.

The apparatus comprises an inner stator 1 and an outer stator 2 arranged outside the inner one. At least the outer surface of the inner stator 1 and the inner surface of the outer stator 2 are conical. A conical rotor 3 is arranged between the inner stator 1 and the outer stator 2. The rotor 3 is arranged to move rotatably between the inner stator 1 and the outer stator 2. The rotor is rotated by a motor 5. The motor 5 can be for instance a hydraulic motor or an electric motor, or another motor completely known per se and suitable for the purpose. The motor 5 is arranged to rotate the rotor 3 via a gear system 4. The rotation speed of the rotor 3 can be controlled in a desired way by means of the gear system 4. On the other hand, for example when an electric motor is used, the gear system 4 is not necessary, because the rotation speed of the rotor 3 can be easily controlled by controlling the rotation speed of the motor 5 in a manner completely known per se.

Further, the apparatus is provided with a supply conduit 6, along which the material to be treated can be fed to the apparatus. The material to be fed to the supply conduit 6 is fed with a feeding device 7. The feeding device 7 can be, for example, a feed screw or a pump or another device completely known per se. In connection with the feeding device 7, there may also be a hopper, to which the materials to be fed to the device are placed. This feeding device allows control of the amount of flow of the material to be fed to the supply conduit.

From the supply conduit 6, the material to be treated flows through a feed opening 8a to the interior of the rotor 3. After this, as the rotor 3 is rotating, the material travels in a recess 9 in the inner stator 1 outwards from the apparatus, in other words upwards as seen in FIG. 1. From the recess 9, the material gets through an opening 8b in the rotor to the outside of the rotor and there in the recess in the outer stator 2 further outwards from the apparatus. The recesses 9 are arranged to end in such a way that substantially all material to be treated can be caused to move through the openings 8b when the recess ends, as far as to the other side of the rotor 3. The edges of the openings 8a and 8b of the rotor 3 are arranged sharp, and in the same way, also the edges of the recesses 9 are arranged sharp in such a way that when the material to be treated moves through the openings 8a and 8b at the boundary surface of the rotor 3 and the stators 1 and 2, the sharp edges of the openings 8a and 8b and recesses 9 cut and grind the material to be treated in such a way that the material is ground and the different materials are mixed.

At the rear end of the apparatus, i.e. at that end from which the material to be treated exits from the equipment, the recesses 9 are arranged to continue as far as to the outlet opening of the apparatus, these recesses 9 having a helical line. In this part, ridges 10 between the recesses 9 are arranged so low that such a great clearance remains between the ridges 10 and the rotor 3 that part of the material to be treated can travel over the ridge 10 from one recess to another. Thus, at the point of the ridge 10, the material to be treated is ground into smaller parts. At the rear end of the apparatus, there may also be helical recesses in the rotor 3, which is shown with broken lines in FIG. 1. In the rotor 3, the recesses are of opposite directions compared with the ones in the stators 1 and 2; in other words the helical recesses 9 are crosswise, whereby the effect of the recesses on the material is extremely powerful.

The apparatus can also be provided with cooling means, for instance a cooling channel 11, by means of which the apparatus and the material treated in it can be cooled in such a way that it remains in a powdery form and does not-stick to the inner surfaces of the apparatus or that the chemical reaction does not start too early or continue too efficiently. Feeding cooling medium to the cooling channel 11 through an inlet channel 12 located close to the rear end of the apparatus and directing the cooling medium out through an outlet channel 13 at the front end of the apparatus allows the rear end of the apparatus to be cooled more efficiently and heat to be transferred from the rear end of the apparatus towards the front end of the apparatus. FIG. 1 shows the cooling means as arranged in the outer stator 2, but if desired, also the inner stator 1 can be provided with cooling means.

The structure and functioning of the apparatus are described in more detail also in U.S. Pat. No. 6,450,429, which is incorporated herein by reference.

Since the apparatus is conical, the clearings between the stators 1 and 2 and the rotor 3 can be adjusted easily and thus also simply by moving the rotor 3 in the axial direction. The feeding device 7, in turn, allows the amount of material to be fed to the apparatus to be controlled easily. Also controlling the rotation speed of the rotor is extremely easy, so controlling the rotation speed of the rotor and the amount of flow of the material to be fed allows the temperature of the material to be treated to be adjusted extremely easily.

Natural fiber material, such as wood, for example in the form of sawdust or chips or another by-product of mechanical wood-processing industry, is fed to the apparatus. In addition to natural fiber material, binding agent, such as plastic, is fed to the apparatus, whereby a composite product is provided with the apparatus. The composite product may be, for instance, a tube, decoration strip or molding, board, plank or another composite part or another corresponding product. A composite product can be used in demanding conditions, such as for instance as a terrace board, because the product can also be made resistant to difficult conditions, such as dampness and cold. In addition to natural fiber and binding agent, material reacting with water is fed to the apparatus. The moisture percentage of the natural fiber material is so high that due to the effect of the water present in the natural fiber material or the moisture released from the natural fiber material, the chemical reaction of the material reacting with water starts. If desired, all materials can be fed as one mixture to the materials treating apparatus with the feeding device 7.

The natural fiber material may thus be, for instance, wet raw wood that has not been dried. The wood can be fed as sawdust or chips, for example. The moisture content of the material is more than 1%. Preferably, the moisture percentage can be even more than 10%, whereby rather wet natural fiber material can be used.

The material used which reacts with water may be, for instance, reaction color. In addition to the reaction color, also soda, which functions as fixing agent, can be fed simultaneously. Due to the effect of the water present in the fiber material, the reaction color reacts chemically with the fiber material, whereby reactive coloring agents form permanently a chemical bond with the fiber material. The total amount of reaction coloring agents does not have to be very large, because the reaction coloring agents are attached to the fiber material. Thus, also the final result is esthetically extremely good. The reaction coloring agent may be, for instance, a product sold under the trade name Bezaktive by the company Bezema AAG. Using three different basic colors, i.e. yellow, magenta and cyan, in different proportions enables formation of all desired color shades.

Also stain colors can be used as the coloring agent for coloring natural fiber material.

The coloring agent may be added for example in a powdery form to the feeding device of the extruder. Further, the coloring agent may be predissolved in water, and this solution may be added to the material. It is also possible to inject the coloring agent to the front section of the extruder.

The binding agent of the composite material may be for instance plastic, such as polyethylene. Thus, for instance silane or silane-based compounds can be used as the chemical agent. Also silane-grafted polyethylene can be mixed into the polyethylene used as the binding agent. Silane or silane-grafted polyethylene reacts due to the effect of the moisture released from the fiber material and the silane crosslinks plastic material, and the silane-grafted polyethylene is crosslinked. Thus, in the process, at its early stage, plastic has low viscosity before the chemical reaction starts. Thus, best possible mixing and dispersion between the plastic and the natural fiber material used are achieved quickly when the plastic is in melt condition. A chemical reaction, i.e. cross-linking, starts inside the materials treating apparatus due to the effect of the heating of the mass and the moisture which is free/released. Due to this, the viscosity of the plastic matrix of the composite is increased, and when the composite material arrives from the extruder to the nozzle part, where that shape is formed for the material, the viscosity of the mixture is no longer at the original low level. Therefore, the final product can be quickly taken out of the nozzle at a high line speed and at a high temperature, in extreme cases even without cooling. The process generates such conditions for silane compounds or silane-grafted polyethylene sorts that no separate catalyst is required for starting and maintaining the reaction, or the amount of catalyst required is fairly small.

Further, the chemicals/silane-grafted plastic sorts used in the cross-linking function as the coupling agent of the natural fiber and the plastic matrix in such a way that no separate coupling agent needs to be used. The cross-linking reaction continues when the product has exited from the nozzle. This continuation of the cross-linking improves the dimensional accuracy and dimensional stability of the product as well as the processability of the product. Even partial cross-linking of the plastic matrix improves the impact strength and elongation in break properties of the composite product. Further, cross-linking improves and facilitates post-formability for the composite product when for instance vacuum molding techniques are used.

The moisture in the natural fiber material, for instance in wood, foams the composite material when it vaporizes. When the composite material is molded into a product and cooled in the nozzle of the extruder, the underpressure generated causes the material to collapse again if non-cross-linked plastic is used as the binding agent. This is because the melt strength of non-cross-linked plastic is not sufficient to keep the structure as a porous cell structure when it is cooled. In the present process, the plastic is cross-linked step by step. At an early stage of the process, when the vaporization of the moisture present in the natural fiber material begins, the plastic is not cross-linked yet, and thus it is capable of foaming. Thus, the density of the composite material is decreased. When the material arrives in the nozzle, it comprises a cross-linked plastic constituent having high melt strength. Thus, this plastic constituent is capable of partly resisting the collapsing phenomenon, and the final product will have lower density than it would without cross-linking. The material density of a composite product manufactured without cross-linking is typically in the order of about 1 300 kg/m³. By cross-linking part of the binding agent, for instance about 5%, a composite product can be formed which has a density of below 1 000 kg/m³.

Cross-linking can also be achieved without water by using peroxide. Thus, the temperature of the composite material in the last part of the nozzle in the materials treating apparatus is raised over the reaction temperature of the peroxide sort in question, for instance over 180° C. Thus, the cross-linking reaction takes place immediately and the binding agent in the composite product can be cross-linked.

All in all, the material reacting with water can, in principle, be any chemical agent or compound exploiting water. Foaming agents can be further mentioned as one agent, whereby the residual moisture obtained from the fiber material contributes to the reaction of the foaming agent.

The amount of natural fiber material in the composite product is typically more than 50%. In connection with this description, amount proportions refer to the weight proportion, for instance percentage by weight. Typically, the proportion of natural fiber material in a plastic composite product is 50 to 90%. The proportion of material reacting with water in the materials to be fed to the materials treating apparatus is rather small, varying from 1‰ to for instance 2%. The proportion of a binding agent, such as plastic, is naturally the rest of the agents to be mixed. In addition to wood, natural fiber material may be, for instance, flax, sisal, hemp, kenaf, jute, straws, such as straws of rice, corn, wheat or other cereal crops, or the like natural fiber materials. Further, the rice husk is a particularly usable natural fiber material.

The binding agent can thus be plastic, for example. Polyethylene and other thermoplastics containing comonomers can be mentioned as preferred examples of plastics. Some polypropylene sorts are such thermoplastics. Further, different combinations of different plastic sorts may be used. Also another adhesive agent that softens in heat, such as natural resin, can be used as the binding agent. Further, for instance pine oil can be used as the binding agent. It is preferable to use pine oil as the binding agent for example together with polyethylene.

The binding agent, such as plastic, can thus be fed to the materials treating apparatus together with the fiber material, or the binding agent can also be added to the process later, for example as liquid material to the mixing part of the extruder. In this case, the extruder can be provided with a second supply conduit 14, to which the liquid material is fed with a second feeding device 15. The second supply conduit 14 and the second feeding device 15 are shown in FIG. 1 symbolically by broken lines. Hence, the natural fiber material, such as wood, is fed with the feeding device 7 to the part of the rotor 3 containing the holes 8a and 8b. After the natural material has been ground and dried, a liquid binding agent and possible additives are fed with the separate second feeding device 15, which may be a small extruder, from the side through the stator 2 to the rotor 3.

Of the agents reacting with water, for example silane is typically fed in the amount of about 2% of the total material amount to be fed to the device. A good final result is achieved also by using 75% wood, 20% low-density polyethylene LDPE and 5% silane-grafted polyethylene. The proportion of reaction coloring agents of the total material amount may vary between 1‰ and 1%.

When a conical extruder is used, a short traveling time can be arranged for the material fed in, and an excessive increase in the temperature of the materials can be prevented. In this way, for example, the material is not cross-linked as a whole in the materials treating apparatus, which would make it more difficult to press the material out of the apparatus. The cross-linking process can, however, start as early as in the apparatus, and the process can also be initiated without a catalyst. With the conical extruder, management of the process conditions and duration of the process can be implemented easily, whereby, as mentioned, the product can be pressed out of the apparatus efficiently and in an easily processable form.

Further, in the conical extruder, at its early stage, the density of the material is smaller than at its final stage. Further, the pressure in the conical extruder increases as one proceeds towards the rear end of the apparatus. Thus, the moisture released from the natural fiber material can be removed backwards from the apparatus, and the material, before its extrusion through a nozzle, is dry.

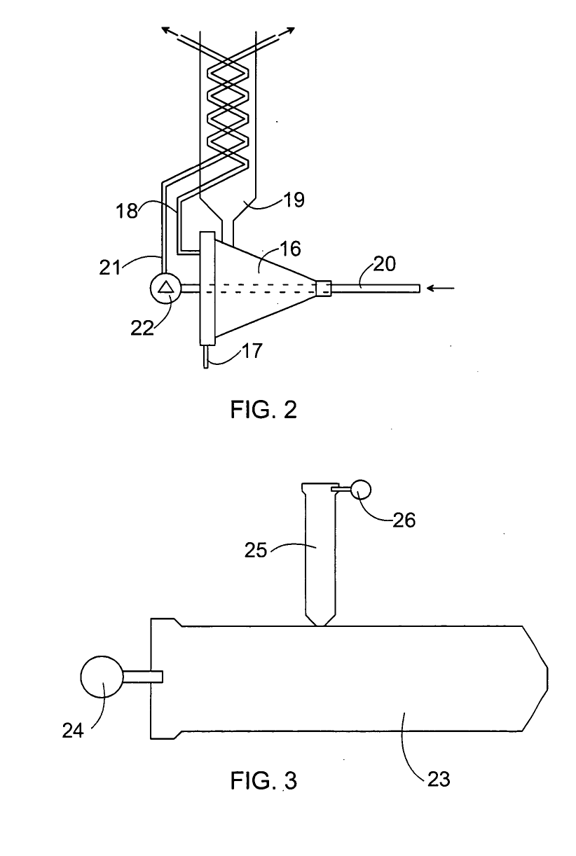

FIG. 2 shows how the heat generated in the process can be utilized. In the conical extruder 16, moist, even wet material is treated. Part of the water present in the material is removed along a water-discharge pipe 17. Due to the heat generated in the process, however, part of the water vaporizes, and it is removed from the rear part of the conical extruder along a steam exhaust pipe 18. The steam exhaust pipe 18, in turn, is arranged to travel in the hopper 19 through the natural fiber material fed to the conical extruder 16. Hence, the natural fiber material is preheated with steam, which makes the absorption of coloring agents, for example, more efficient.

If the composite product 20 is hollow, the product 20 and the conical extruder 16 can be cooled by sucking with a cooling pipe 21 and a blower 22 air through the product 20 and the conical extruder 16. This warm air can also be directed via the hopper 19 to heat the material to be fed to the conical extruder 16.

FIG. 3 shows a materials treating apparatus by means of which also the method according to the invention can be implemented. The apparatus comprises a conventional cylinder-shaped main extruder 23 with which the composite product is manufactured. Natural fiber material is fed to the main extruder 23 with a feeding device 24. The binding agent can be fed to the main extruder 23 also with a conventional cylinder-shaped side extruder 25. The material is fed to the side extruder 25 with a feeding device 26.

The drawings and the related description are only intended to illustrate the idea of the invention. The details of the invention may vary within the scope of the claims. Thus, the method can be implemented with devices different from the ones shown in connection with the drawings. One conical extruder that is particularly suitable for the purpose is disclosed in U.S. patent application 20 030 072 211, which is incorporated herein by reference. The different materials of the composite product can be fed to the materials treating apparatus either simultaneously, or part of the material can be fed in the conical extruder to the outside of the conical extruder rotor and part to the inside of the conical-extruder rotor. For instance in the conical extruder with efficient mixing according to U.S. patent application 20 030 072 211, the natural fiber material can be fed to a first side of the rotor and the binding agent and possible additives to a second side of the rotor. The rear end of the rotor can thus be provided with holes, whereby the materials can be mixed efficiently by means of the rotor part containing holes. In addition, part of the materials can be fed to the process at a later stage than first materials.

1. A method of manufacturing a composite product,
comprising
providing one or more materials treating apparatus;
feeding natural fiber material, binding agent and material reacting with water to the materials treating apparatus,
whereby the natural fiber material is fed so moist that it moisture percentage is more than 1%, whereby said material reacting with water reacts with the water present in said natural fiber material and/or released from it; and
forming a composite product with the materials treating apparatus.

2. A method according to claim 1, wherein the moisture percentage of the natural fiber material is more than 10%.

3. A method according to claim 1, wherein the moisture percentage of the natural fiber material is 1 to 50%.

4. A method according to claim 1, wherein moisture is removed from the natural fiber material in the material treating apparatus before pressing the material out of this apparatus.

5. A method according to claim 1, wherein the reaction of the material reacting with water is started in the materials treating apparatus by means of heat and moisture.

6. A method according to claim 1, wherein the binding agent is plastic.

7. A method according to claim 6, wherein the material reacting with water is a cross-linking agent or a plastic compound cross-linkable by the effect of water.

8. A method according to claim 1, wherein the material reacting with water is a coloring agent.

9. A method according to claim 8, wherein natural fiber material is colored with the coloring agent.

10. A method according to claim 9, wherein the natural fiber material is wood.

11. A method according to claim 1, wherein the natural fiber material is wood.

12. A method according to claim 6, wherein the natural fiber material is wood.

13. A method according to claim 7, wherein the natural fiber material is wood.

14. A method according to claim 1, wherein the natural fiber material is the rice husk.

15. A method according to claim 1, wherein the materials treating apparatus is a conical extruder.

16. A method according to claim 1, wherein the binding agent is pine oil.

17. A method according to claim 4, wherein the moisture having been removed from the natural fiber material is directed as steam to heat the natural fiber material to be fed to the materials treating apparatus.

18-29. (canceled)
